(19) United States
(12) Patent Application Publication
(10) Pub. No.: US 2025/0382934 A1
(43) Pub. Date: Dec. 18, 2025

(54) INJECTOR ASSEMBLY FOR AN ENGINE, AND AIRCRAFT

(71) Applicant: Rolls-Royce Deutschland Ltd & Vo KG, Blankenfelde-Mahlow (DE)

(72) Inventor: Ruud EGGELS, Berlin (DE)

(21) Appl. No.: 19/235,046

(22) Filed: Jun. 11, 2025

(30) Foreign Application Priority Data
Jun. 13, 2024 (DE) 10 2024 205 469.0

(51) Int. Cl. F02M 43/04; F02M 55/00

(52) U.S. Cl. CPC F02M 43/04; F02M 55/008

(57) ABSTRACT

The invention relates to an injector assembly for a gas turbine, in particular an engine of an aircraft, for introducing a gaseous fuel and a liquid fuel, and also air, into a combustion chamber, having an injector shaft and an injector main body oriented along an injector longitudinal axis, wherein the injector main body includes:
a first gas duct, which is arranged centrally on the injector longitudinal axis and has a downstream outlet opening, for introducing a gas flow,
at least one air duct arranged in radially outwardly encircling fashion around the first gas duct, as second gas duct, and
a liquid fuel injection means, which is arranged radially around the first gas duct, for introducing the liquid fuel into the combustion chamber.

An advantageous emission characteristic can be achieved by the first gas duct being designed exclusively to introduce the gaseous fuel into the combustion chamber.

This application claims priority to German Patent Application 102024205469.0 filed Jun. 13, 2024, the entirety of which is incorporated by reference herein.

The invention relates to an injector assembly for an engine, in particular of an aircraft, for introducing a gaseous fuel and a liquid fuel, and also air, into a combustion chamber, having an injector shaft and an injector main body oriented along an injector longitudinal axis, wherein the injector main body comprises:
a first gas duct, which is arranged centrally on the injector longitudinal axis and has a downstream outlet opening, for introducing a gas flow,
at least one air duct arranged in radially outwardly encircling fashion around the first gas duct, as second gas duct, and
a liquid fuel injection means, which is arranged radially around the first gas duct, for introducing the liquid fuel into the combustion chamber.
   The invention also relates to an aircraft having an injector assembly.

An injector assembly, or nozzle assembly, of the type mentioned at the outset is specified, for example, in DE 10 2022 201 182 A1. In this case, a fuel injection means for the gaseous fuel is arranged radially outwardly around a central air duct, which runs on a nozzle longitudinal axis, and a liquid fuel injection means.

US 2024/0044293 A1, U.S. Pat. No. 10,794,596 B3, US 2016/0201897 A1 and U.S. Pat. No. 11,525,403 B2 each disclose an injector assembly for introducing a gaseous fuel and a liquid fuel having a central air duct.

U.S. Pat. No. 6,123,273 discloses a fuel injector for a gas turbine for adding a liquid fuel and a gaseous fuel to a combustion chamber, wherein a supply assembly for gaseous fuel is arranged radially outwardly around a supply assembly for liquid fuel.

U.S. Pat. No. 10,054,093 B2 discloses a fuel injector for a gas turbine for adding a liquid fuel to a combustion chamber.

The invention is based on the object of providing an injector assembly of the type mentioned at the outset, and an aircraft, with an advantageous emission characteristic.

The object is achieved for the injector assembly by the features of claim 1 and for the aircraft by the features of claim 15.

With respect to the injector assembly, provision is made for the first gas duct to be designed exclusively to introduce the gaseous fuel, not to introduce a liquid fuel or an air flow, into the combustion chamber. An upstream, possibly closable or closed, air inlet opening is not present on the first gas duct.

For the introduction into the combustion chamber, the gaseous fuel can be introduced directly from the first gas duct into the combustion chamber or indirectly into same. In the case of indirect introduction, the gaseous fuel is first introduced axially into a further duct, in particular into an air duct surrounding the first gas duct, and added to the combustion chamber at least partially premixed with the (gas, in particular air) flow flowing through the further duct.

A further gas fuel injection means, in addition to the first gas duct, is preferably not present on the injector assembly.

The gaseous fuel is formed in particular from hydrogen and/or comprises hydrogen. The liquid fuel is formed in particular by kerosene and/or a sustainable alternative fuel (SAF). The aircraft has a correspondingly configured fuel periphery.

Due to the design according to the invention, the injector assembly can be operated both with gaseous and with liquid fuel, in each case separately or with both fuel types at the same time, a flow pattern which is advantageous with regard to mixing being formed in the combustion chamber for the benefit of low-emission combustion.

Provision is preferably made for a gas fuel supply line for conducting the gaseous fuel, and a liquid fuel supply line for conducting the liquid fuel, to the injector main body to be present in the injector shaft, wherein, in particular at least at the transition to the (or upstream within the) injector main body, the gas fuel supply line is arranged on an air inflow side and the liquid fuel supply line is arranged on an air outflow side of the injector shaft. The gas fuel supply line is thus arranged at a further axial spacing from the combustion chamber, with respect to the air inflow direction of the injector on the upstream side. This makes it possible for the hydrogen to be introduced into the central, first gas duct in a comparatively simple manner in terms of manufacturing technology.

Particularly preferably, the at least one air duct, as first air duct, is arranged at least partially in radially directly (without interposition of a further fluid duct) encircling fashion around the first gas duct and has an upstream (air) inlet opening and a down-stream outlet opening. Preferably, the first gas duct is surrounded over its entire length by the first air duct. The wall present between the first gas duct and the first air duct (as second gas duct) is preferably in the form of a cylindrical tube portion.

Preferably, the upstream inlet opening is arranged centrally on (coaxially with respect to) the injector longitudinal axis and/or at the upstream end of the injector main body, and is in particular of at least substantially circular (or circular ring) form. In this way, during operation, a portion of the air flowing into the injector assembly, upstream of the fuel addition, enters the injector main body, more precisely the first air duct, and forms an air flow into which the gaseous fuel can be mixed.

In different design variants, the downstream outlet opening of the first gas duct may be arranged upstream of or at the level of the downstream outlet opening of the first air duct. When arranged upstream of the outlet opening of the first air duct, during operation, the gaseous fuel is first added to the surrounding air flow and at least partially pre-mixed therewith. Downstream of the outlet opening of the first gas duct, the first air duct then forms the central gas duct which runs on the injector longitudinal axis and by which the air/fuel mixture is guided to the combustion chamber and added to the combustion chamber through the outlet opening. The outlet opening of the first gas duct may, for example, be arranged in an upstream half of the injector main body.

When arranged at the level of the outlet opening of the first air duct into the combustion chamber, during operation, the gaseous fuel is introduced in non-premixed form into the combustion chamber. This makes it possible to avoid flashback into the first air duct.

To impart swirl to the flow of the gaseous fuel, a swirl generator is preferably arranged within the first gas duct.

For the benefit of simple manufacture, the first gas duct may be formed by the gas fuel supply line, wherein the gas fuel supply line is continued into the injector main body, in particular into the first air duct, and merges by means of a transition, for example by means of a curvature positioned within the first air duct, into a symmetrical downstream end portion of the gas fuel supply line, said end portion running on the injector longitudinal axis and forming the first gas duct. In this case, the gas fuel supply line is preferably in the form of a tube at least within the injector main body.

To impart swirl to the air flow, a swirl generator is preferably arranged within the first air duct in an upstream half and/or in a downstream half of the injector main body, wherein in particular the swirl generator is arranged upstream of the outlet opening of the first gas duct. This can have a positive influence on the mixing of the fuel and/or the flow within the combustion chamber. Particularly when the swirl generator is arranged in the downstream half of the injector main body, the swirl generator may additionally perform a mechanical support function with respect to the first gas duct. The first air duct may have a cross-sectional constriction to accelerate the flow at the level and/or downstream of the swirl generator and/or the outlet opening of the first gas duct.

In a preferred design variant, at least one liquid fuel duct with a downstream liquid fuel injection means is present downstream of the liquid fuel supply line within the injector main body, wherein the at least one liquid fuel duct is arranged directly (without interposition of a further fluid duct) radially around the first air duct and wherein the liquid fuel injection means is in particular assigned an atomizer assembly with a film applicator surface. Preferably, a plurality of discrete liquid fuel ducts are present, which may run axially-radially inward with their end portions. At least in certain portions, an at least partially encirclingly contiguous liquid fuel annular duct may also be present.

Preferably, the liquid fuel duct opens out into the first air duct by means of the liquid fuel injection means, wherein in particular the film applicator surface is designed to be able to be flowed over by an air flow flowing through the first air duct. In this case, in particular the film applicator surface is at least partially formed by a wall around the first air duct. In this way, during operation, the air flowing through the first air duct (possibly premixed with the gaseous fuel) can advantageously advance the fuel film.

Preferably, the first gas duct, at least at the outlet opening, is designed to be able to be flowed through at high speed, between 50 m/s and 300 m/s, in particular between 50 m/s and 150 m/s, and/or the first air duct, at least at the outlet opening, is designed to be able to be flowed through at high speed, between 50 m/s and 150 m/s. In particular, the flow cross section is designed correspondingly taking account of the operational boundary conditions. This shifts the combustion zone further into the combustion chamber and reduces the thermal load on the injector assembly. When the air flow is at least partially premixed with the gaseous fuel, the high speed also prevents flashback into the first air duct.

For the benefit of optimized flow conditions in the combustion chamber, a second air duct (i.e. a third gas duct), in particular with a swirl generator, is preferably arranged in radially (directly, without interposition of a further fluid duct) outwardly encircling fashion around the liquid fuel duct. The inlet opening into this second air duct is preferably positioned in the downstream half of the injector main body. The second air duct is in particular of annularly encircling form.

For the further optimization of the flow conditions, a third air duct (i.e. a fourth gas duct), in particular with a swirl generator, is preferably arranged in radially outwardly encircling fashion around the second air duct. The inlet opening into this third air duct is preferably positioned in the downstream half of the injector main body. The third air duct is in particular of annularly encircling form.

A preferred design of the air ducts is such that the second air duct and/or the third air duct have/has, on the downstream side, an (axially-) radially inwardly oriented end portion. This imparts an additional radial impulse inward, toward the injector longitudinal axis, to the flow, before the flow widens radially toward the outside on account of the circumferential swirl that is preferably present, and forms a recirculation zone that stabilizes the combustion.

The invention will be explained in more detail below on the basis of exemplary embodiments with reference to the drawings, in which:

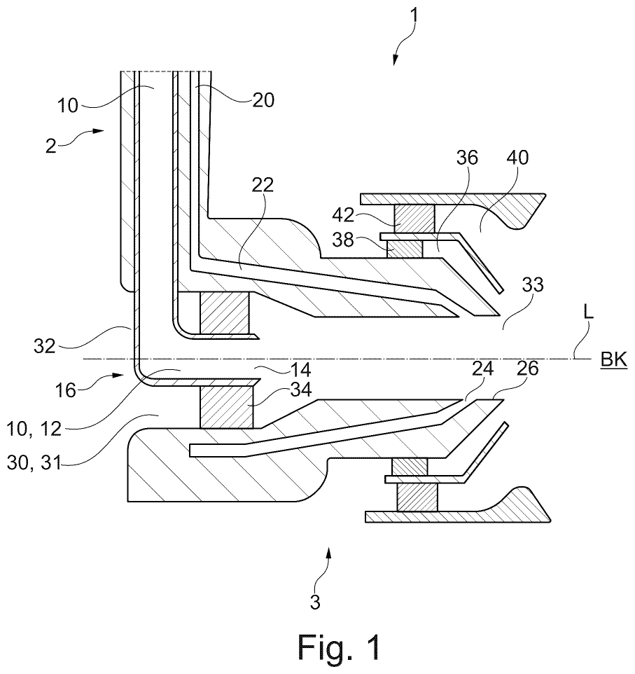

FIG. 1 shows an injector assembly according to the invention for introducing a gaseous fuel and a liquid fuel into a combustion chamber of an engine in a schematic illustration in a longitudinal section along an injector longitudinal axis,

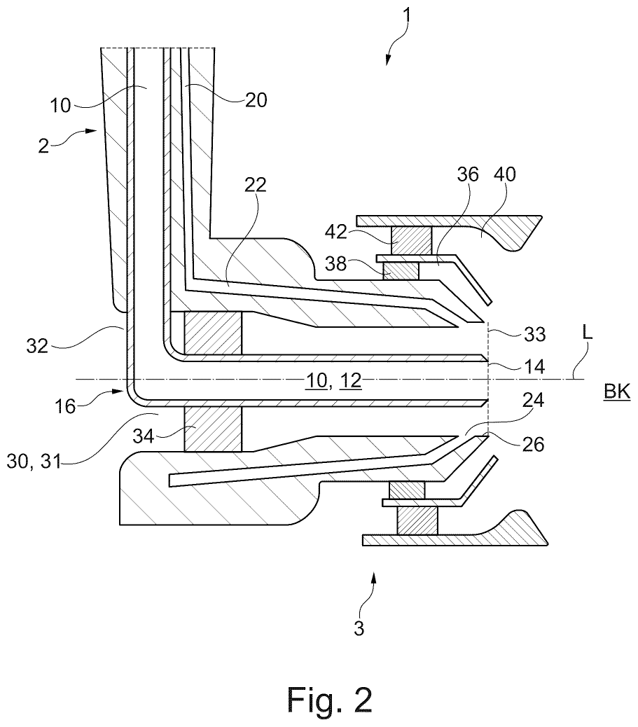

FIG. 2 shows a second design variant of the injector assembly in a schematic illustration in a longitudinal section along the injector longitudinal axis,

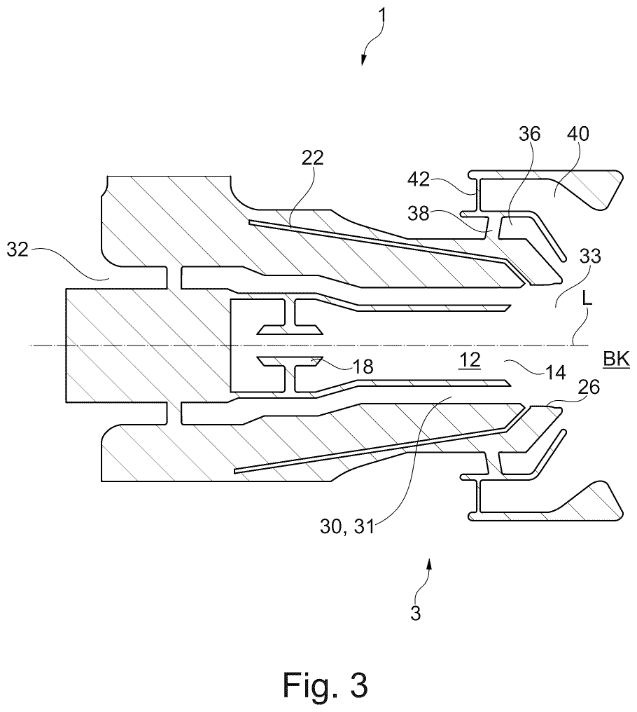

FIG. 3 shows a third design variant of the injector assembly in a schematic illustration in a longitudinal section along the injector longitudinal axis, and

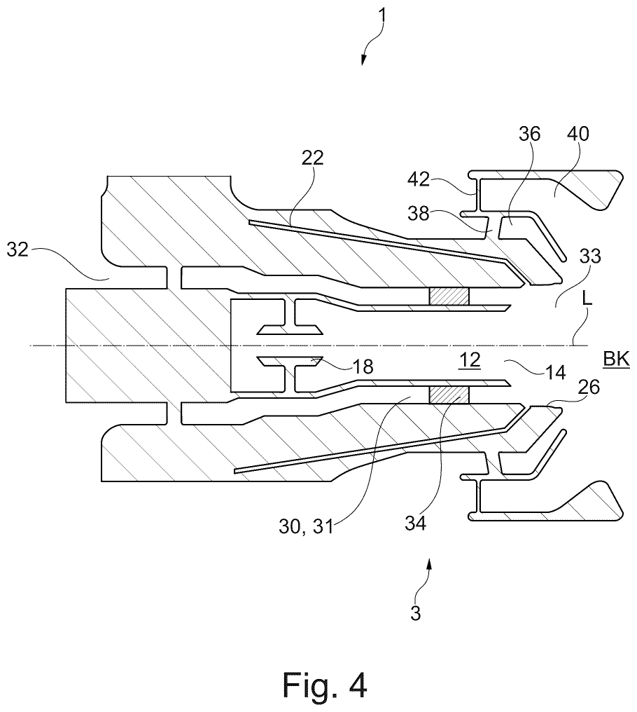

FIG. 4 shows a fourth design variant of the injector assembly in a schematic illustration in a longitudinal section along the injector longitudinal axis.

FIG. 1 shows, in a schematic illustration in longitudinal section, an injector assembly 1 for introducing fuel and air into a combustion chamber BK of an engine, in particular of an aircraft. The injector assembly 1 has an injector shaft 2 and an injector main body 3 arranged on the injector shaft 2. The injector main body 3 is oriented along an injector longitudinal axis L running at an angle (in the present case substantially orthogonally) to the injector shaft 2.

The injector assembly 1 is configured for operation with two types of fuels, a gaseous fuel and a liquid fuel. By means of the injector assembly 1, the fuels can be supplied to the combustion chamber BK both simultaneously (in parallel) in a combined operation and individually in a separate operation by liquid and/or gaseous fuel.

Both a gas fuel supply line 10 and a liquid fuel supply line 20 are arranged in the injector shaft 2 for the fuel supply line. In FIG. 1, the two fuel supply lines 10, 20 by way of example run parallel to one another, with other arrangements also being possible, e.g. an arrangement of the liquid fuel supply line 20 within the gas fuel supply line 10 (not shown here).

The gaseous fuel is formed in particular from hydrogen and/or comprises hydrogen. The liquid fuel is formed in particular by kerosene and/or a sustainable alternative fuel (SAF). The aircraft has a correspondingly configured fuel periphery (not shown in FIG. 1).

The injector assembly 1 comprises a centrally arranged first gas duct 12 which extends on the injector longitudinal axis L, has a downstream outlet opening 14 and is designed according to the invention exclusively to introduce the gaseous fuel, not the liquid fuel or an air flow, into the combustion chamber BK.

Preferably, a swirl generator 18 (not illustrated in FIG. 1 and the FIG. 2) is arranged in the first gas duct 12 (cf. FIG. 3 and FIG. 4).

Arranged within the injector main body 3 in annularly radially directly encircling fashion around the first gas duct 12 (i.e. without interposition of a further fluid duct and preferably separated merely by a for example cylindrical tube wall) is a second gas duct 30, which over its entire length is coaxial (with respect to the injector longitudinal axis L) with the first gas duct 12. The second gas duct 30 is designed to be able to be flowed through by air as first air duct 31, it having a for example substantially circular, upstream inlet opening 32 and a for example substantially circular, downstream outlet opening 33. The upstream inlet opening 32 is arranged at the upstream end of the injector main body 3.

The first gas duct 12 is formed in particular by a tubular, downstream end portion of the gas fuel supply line 10. In this case, the gas fuel supply line 10 is guided by means of a transition, which in the present case is in the form of a curvature 16 of the tubular gas fuel supply line 10, from the injector shaft 2 into the injector main body 3, in particular into the first air duct 31. The downstream end portion of the gas fuel supply line 10 runs symmetrically on the injector longitudinal axis L, extending along the latter, and opens out into the outlet opening 14. The preferably circular flow cross section of the gas fuel supply line 10 within the downstream end portion may have the same or at least in certain portions a smaller cross-sectional area than within the injector shaft 2 and/or may be designed to be constant within the downstream end portion.

It is also possible for a line portion to be present within a swirl generator 34 arranged in the first air duct 31, for conducting the gaseous fuel through the gas fuel supply line 10 and the swirl generator 34 into the first gas duct 12 (not shown here).

A further gas fuel injection means, in addition to the first gas duct 12, is preferably not present on the injector assembly 1.

The downstream outlet opening 14 of the gas fuel supply line 10, out of which the gaseous fuel flows during operation, is in the design variant shown in FIG. 1 arranged by way of example upstream of the outlet opening 33 of the first air duct 31 into the combustion chamber BK. By way of example, the outlet opening 14 lies in the up-stream half of the injector main body 3. Thus, in the portion lying downstream of the outlet opening 14, the second gas duct 30 or the first air duct 31 forms the central duct running on the injector longitudinal axis. In this way, during operation, the supplied gaseous fuel is first added to the first air duct 31, to the air flow flowing therethrough, by means of the outlet opening 14 and at least partial premixing of the gaseous fuel with this airflow is obtained. The obtained mixture flows, as central gas flow, further through the portion of the second gas duct 30 that extends downstream of the outlet opening 14 and through the outlet opening 33 into the combustion chamber BK.

Particularly preferably, the first air duct 31 is designed to allow the air flow to exit at high speed, for example between 50 m/s and 150 m/s, and/or the first gas duct 12 is designed to allow the flow of the gaseous fuel to exit at high speed, for example between 50 m/s and 300 m/s, preferably between 50 m/s and 150 m/s. In this way, the combustion zone during operation with the highly reactive gaseous fuel can be shifted downstream of the injector assembly 1, the thermal load on the injector assembly 1 thus being reduced.

The liquid fuel supply line 20 merges, at the injector main body-side end of the injector shaft 2 or within the injector main body 3, into at least one liquid fuel duct 22 for supplying the liquid fuel to a downstream liquid fuel injection means 24. The at least one liquid fuel duct 22 is arranged radially preferably directly (without interposition of a further fluid duct) around the first air duct 31. Preferably, a plurality of for example discrete liquid fuel ducts 22 running axially and/or axially-radially inward are present. As an alternative or in addition, at least in certain portions an individual liquid fuel duct 22 in the form of an at least substantially completely encircling, contiguous fuel annular duct is present (not shown here). The liquid fuel duct 22 may also be provided in particular with swirl elements for swirling the liquid fuel (not shown here). The downstream liquid fuel injection means 24 preferably has an atomizer assembly in particular in the form of a film applicator assembly, with a film applicator surface 26.

The liquid fuel injection means 24 is arranged at the downstream end of the first air duct 31 in order to inject the liquid fuel into the air flow flowing through the first air duct 31. The film applicator surface 26 is arranged in at least partially encircling fashion around a downstream portion of the first air duct 31 and is flowed over during operation by air (or a mixture of air and the gaseous fuel) flowing through the first air duct 31.

Arranged in a downstream end portion of the injector main body 3 in radially directly outwardly encircling fashion around the liquid fuel injection means 24 are preferably two outer air ducts, a second air duct 36 and a third air duct 40. The injector assembly 1 shown thus has a total of three air ducts. The air ducts 36 and 40 are separated from one another by means of an air-guiding element. Preferably, to impart swirl to the air flow during operation, a swirl generator 38 is arranged in the second air duct 36 and a swirl generator 42 is arranged in the third air duct 40.

The second air duct 36 and the third air duct 40 have end portions which are oriented axially-radially inward on the downstream side, in order to during operation impart an inward radial flow impulse to the air flowing through said ducts. In this way, the air flow is first deflected inward when entering the combustion chamber BK, before the air flows radially outward due to the imparting of swirl and stabilizes the combustion zone by means of a recirculation zone.

Within the first air duct 31, the swirl generator 34 is preferably arranged upstream of the outlet opening 14 of the first gas duct 12.

FIG. 2 shows a second design variant of the injector assembly 1, the outlet opening 14 of the gas fuel supply line 10 or of the first gas duct 12 being arranged at the level of the outlet opening 33 of the first air duct 31. In this way, the gaseous fuel is supplied directly into the combustion chamber BK without being premixed with the air.

The rest of the design of the injector assembly 1 corresponds to the design shown in FIG. 1.

FIG. 3 shows a third design variant of the injector assembly 1, the swirl generator 18 which is preferably arranged within the first gas duct 12 being illustrated. The outlet opening 14 is by way of example arranged in the downstream half of the injector main body 3, but preferably upstream of the film applicator surface 26. In the design variant shown in FIG. 3, the injector shaft 2 with the present liquid fuel supply line 20 and the gas fuel supply line 10 and the transition thereof into the injector main body 3 (cf. FIG. 1 and FIG. 2) are not illustrated.

FIG. 4 shows a fourth design variant of the injector assembly 1, based on the design variant shown in FIG. 3 (without illustration of the present injector shaft 2 with the liquid fuel supply line 20, the gas fuel supply line 10 and the transition thereof into the injector main body 3, cf. FIG. 1 and FIG. 2). In contrast to FIG. 3, the swirl generator 34 arranged within the first air duct 31 is arranged in the downstream half of the injector main body 3, but upstream of the outlet opening 14. In this way, the swirl generator 34 additionally brings about mechanical stabilization of the first gas duct 12.

The central flow contributes to extremely advantageous emission characteristics, with low nitrogen oxide emissions (NOx).

### LIST OF REFERENCE SIGNS

1 Injector assembly
2 Injector shaft
3 Injector main body
10 Gas fuel supply line
12 First gas duct
14 Outlet opening
16 Curvature
18 Swirl generator
20 Liquid fuel supply line
22 Liquid fuel duct
24 Liquid fuel injection means
26 Film applicator surface
30 Second gas duct
31 First air duct
32 Inlet opening
33 Outlet opening
34 Swirl generator
36 Second air duct
38 Swirl generator
40 Third air duct
42 Swirl generator
BK Combustion chamber
L Injector longitudinal axis

1. An injector assembly for an engine, in particular of an aircraft, for introducing a gaseous fuel and a liquid fuel, and also air, into a combustion chamber, having an injector shaft and an injector main body oriented along an injector longitudinal axis, wherein the injector main body comprises:
a first gas duct, which is arranged centrally on the injector longitudinal axis and has a downstream outlet opening, for introducing a gas flow,
at least one air duct arranged in radially outwardly encircling fashion around the first gas duct, as second gas duct, and
a liquid fuel injection means, which is arranged radially outwardly around the first gas duct, for introducing the liquid fuel into the combustion chamber, characterized in that
the first gas duct is designed exclusively to introduce the gaseous fuel into the combustion chamber.

2. The injector assembly according to claim 1, wherein a gas fuel supply line for conducting the gaseous fuel, and a liquid fuel supply line for conducting the liquid fuel, to the injector main body are present in the injector shaft, wherein, in particular at least at the transition to the injector main body, the gas fuel supply line is arranged on an air inflow side and the liquid fuel supply line is arranged on an air outflow side of the injector shaft.

3. The injector assembly according to claim 1, wherein the at least one air duct, as first air duct, is arranged at least partially in radially directly encircling fashion around the first gas duct and has an upstream inlet opening and a downstream outlet opening.

4. The injector assembly according to claim 3, wherein the upstream inlet opening is arranged centrally on the injector longitudinal axis and/or at the upstream end of the injector main body.

5. The injector assembly according to claim 3, wherein the downstream outlet opening of the first gas duct is arranged upstream of or at the level of the downstream outlet opening of the first air duct.

6. The injector assembly according to claim 1, wherein a swirl generator is arranged within the first gas duct.

7. The injector assembly according to claim 1, wherein the first gas duct is formed by the gas fuel supply line, wherein the gas fuel supply line is continued into the injector main body, in particular into the first air duct, and merges by means of a transition, for example by means of a curvature positioned within the first air duct, into a symmetrical downstream end portion of the gas fuel supply line, said end portion running on the injector longitudinal axis and forming the first gas duct.

8. The injector assembly according to claim 1, wherein a swirl generator is arranged within the first air duct in an upstream half and/or in a downstream half of the injector main body, wherein in particular the swirl generator is arranged upstream of the outlet opening of the first gas duct.

9. The injector assembly according to claim 1, wherein at least one liquid fuel duct with a downstream liquid fuel injection means is present downstream of the liquid fuel supply line within the injector main body, wherein the at least one liquid fuel duct is arranged directly radially around the first air duct and wherein the liquid fuel injection means is in particular assigned an atomizer assembly with a film applicator surface.

10. The injector assembly according to claim 1, wherein the liquid fuel duct opens out into the first air duct by means of the liquid fuel injection means, wherein in particular the film applicator surface is designed to be able to be flowed over by an air flow flowing through the first air duct.

11. The injector assembly according to claim 1, wherein the first gas duct, at least at the outlet opening, is designed to be able to be flowed through at high speed, between 50 m/s and 300 m/s, in particular between 50 m/s and 150 m/s, and/or the first air duct, at least at the outlet opening, is designed to be able to be flowed through at high speed, between 50 m/s and 150 m/s.

12. The injector assembly according to claim 9, wherein a second air duct, in particular with a swirl generator, is arranged in radially outwardly encircling fashion around the liquid fuel duct.

13. The injector assembly according to claim 12, wherein a third air duct, in particular with a swirl generator, is arranged in radially outwardly encircling fashion around the second air duct.

14. The injector assembly according to claim 12, wherein the second air duct and/or the third air duct has, on the downstream side, a radially inwardly oriented end portion.

15. An aircraft having an injector assembly according to one of the preceding claims, and having a fuel periphery designed for the operation of the aircraft with a gaseous fuel and with a liquid fuel.
